(19) United States
(12) Patent Application Publication
(10) Pub. No.: US 2007/0229462 A1
(43) Pub. Date: Oct. 4, 2007

(54) System and method for mapping user-input controls to corresponding regions of a user display

(76) Inventors: Thanh Tal Eric Huynh, Le Plessis Robinson (FR); Ludovic Barra, Saint Cloud (FR)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/395,005

(22) Filed: Mar. 31, 2006

(51) Int. Cl. G09G 5/00

(52) U.S. Cl. 345/169

(57) ABSTRACT

A mobile phone. The mobile phone includes a display, a keypad including a plurality of keys, and a controller configured to receive input commands from the keypad and to deliver video information to the display. The mobile phone also includes a memory holding game instructions that, when executed by the controller, map a subset of the keypad to the display such that the display is functionally divided into a plurality of segments, one for each mapped key, and where each mapped key controls game action at the display segment to which that key is mapped.

### BACKGROUND

Portable computing devices, including mobile phones, can be used to play games. Up until recently, the processing limitations of portable computing devices limited the complexity of the games and other programs that could be executed. Now that more powerful computing platforms are being implemented in mobile packages, other limitations inherent to a small computing package are posing new challenges.

As an example, even when a mobile phone has the processing power to execute a complex game program, the small form factor and limited control mechanisms of the mobile phone make it difficult to implement a satisfactory control system for the game.

### SUMMARY

The inventors herein have recognized a novel control strategy that can be used to play games and/or execute other programs on portable computing devices, including mobile phones. According to one aspect of the disclosure, a mobile phone includes a display, a keypad including a plurality of keys, and a controller configured to receive input commands from the keypad and to deliver video information to the display. The mobile phone also includes a memory holding game instructions that, when executed by the controller, map a subset of the keypad to the display such that the display is functionally divided into a plurality of segments, one for each mapped key, and where each mapped key controls game action at the display segment to which that key is mapped. In this manner, various relatively complicated games, including, but not limited to, three-dimensional, first-person-shooter games, can be played on a mobile phone.

### BRIEF DESCRIPTION OF THE DRAWINGS

FIG. 1 schematically shows an exemplary mobile computing device in accordance with the present disclosure.

FIG. 2 shows a mobile phone running a game program that functionally divides a display into a plurality of segments, each of which has one of the numeric keys mapped thereto.

FIG. 3 shows a 5×5 display segmentation based on a 3×3 keypad.

FIG. 4 shows the mobile phone of FIG. 2 as the “4-key” is activated to shoot a game-enemy that is present in the “4-segment” of the display.

FIG. 5 shows the mobile phone of FIG. 2 as a key combination is used to activate a sniper telescope within the game.

### WRITTEN DESCRIPTION

The present disclosure is directed toward a system and method for mapping one or more keys from a user input device to a display. According to some aspects of the disclosure, a portable computing device, such as a mobile phone, can be configured to execute a game program in which a mapped key is used to perform a game action at the display location corresponding to the mapped key. Some aspects of such a game program can be controlled by user inputs that are not mapped to a particular display location. The game program can be a three-dimensional game program, although this is not required.

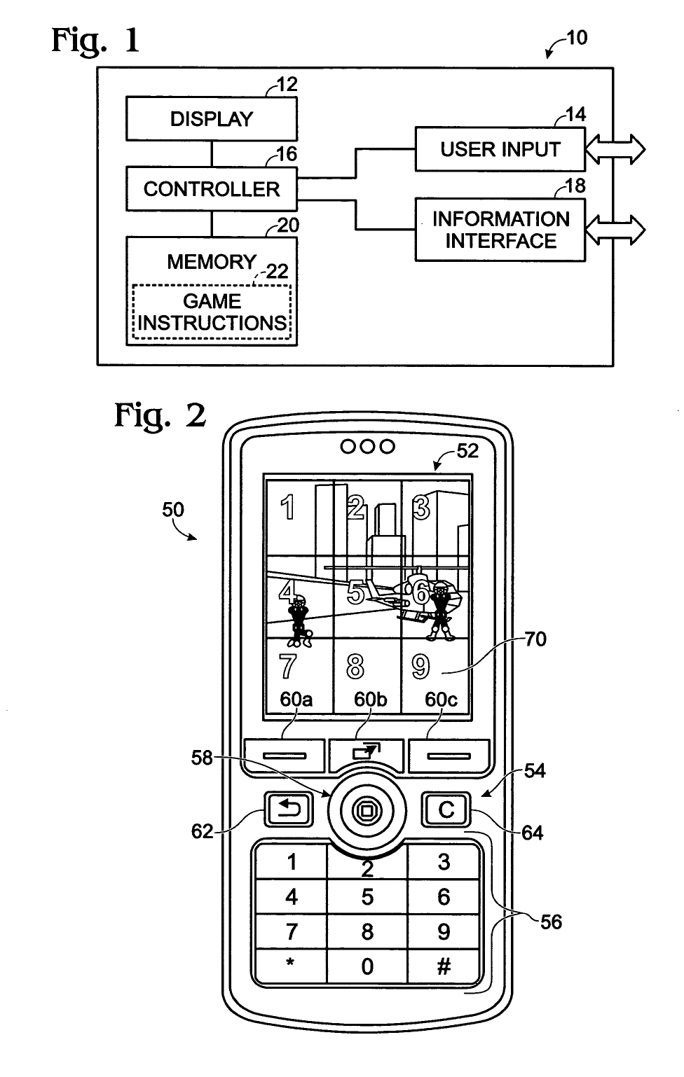

FIG. 1 schematically shows a portable computing device 10, which includes a display 12, user input 14, controller 16, information interface 18, and memory 20. Portable computing device 10 is provided as a nonlimiting example of a computing device that can map user-input controls to corresponding regions of a user display. Computing devices configured differently than shown in FIG. 1 can be used without departing from the scope of this disclosure. Key-to-display mapping can be performed by virtually any device, or combination of devices, which collectively include a user input having a plurality of keys and a display to which the keys can be mapped.

Display 12 can include a rectangular liquid crystal display (LCD), although this is not required. Other types of displays, including, but not limited to, plasma displays, organic light emitting diode (OLED) displays, and projected displays can be used. Display 12 can be a color display, a monochromatic display, or a dual mode display that can operate in a color mode or a monochromatic mode. Display 12 can have virtually any resolution, including resolutions commonly used on mobile computing devices (e.g., 128×160, 176×208, 176×220, 208×320, 240×320, 128×128, 160×160, 240×240, 320×320).

Display 12 can be configured to present video images to a user. Video images can include, but are not limited to, graphical user interfaces, motion video, still video, and visual content from application programs such as games, clocks, calendars, address books, and the like.

User input 14 can include a plurality of keys, buttons, dials, switches, joysticks, touch-screens, soft keys, and other mechanisms that collectively can be used to control one or more functions of portable computing device 10. The number and/or types of control mechanisms that constitute user input 14 can be selected based on the intended use of the computing device. For example, a mobile phone can include at least a ten digit keypad for dialing phone numbers. A mobile phone can also include a joystick and soft keys for navigating menus, a dial for adjusting volume, and/or other controls for performing various functions. As described in more detail below, a subset of the individual mechanisms that collectively constitute user input 14 can be mapped to display 12.

Controller 16 can include hardware, software, and/or firmware that manages cooperation between the various components of computing device 10. The controller can include one or more processors, application specific integrated circuits (ASICs), and/or other devices that can execute instructions. A controller can run an operating system and/or one or more application programs (including game programs), and a controller can encode and/or decode audio and/or video information. A controller can include a software virtual machine that allows code generically written for the virtual machine to be executed on a variety of different devices, including computing device 10.

Information interface 18 can be configured to input and/or output information from/to one or more sources/recipients. For example, an information interface can include a cellular radio for sending and receiving cellular communications or a satellite transceiver for sending and receiving satellite communications. An information interface can additionally or alternatively include a wireless network radio for sending and receiving information in accordance with 802.11a/b/g, Bluetooth, or another wireless transmission protocol. An information interface can additionally or alternatively include a wired interface for sending and receiving information in accordance with IEEE1394, USB, USB 2.0, or another wired transmission protocol. In some embodiments, an information interface can be configured to read data from and/or write data to one or more different types of media, including, but not limited to, semiconductor memory (e.g., Flash memory), optical discs (e.g., CD, DVD), magnetic memory, or another storage mechanism. Such media can be removable, peripheral, or integrated.

Memory 20 can include volatile and/or nonvolatile portions that can be used to semi-permanently or temporarily store, buffer, or otherwise hold digital information, including instructions in the form of compiled code, uncompiled code, and/or intermediate or bytecode. As a nonlimiting example, memory 20 can include semiconductor memory for storing an operating system, one or more application programs, and information that a user can repeatedly access. Memory 20 can also include RAM that can be used to hold and manipulate program code and data while running an operating system, various application programs, and/or other instruction sets. A set of game instructions that collectively constitute the below described game program are schematically shown in dashed lines at 22. Such game instructions can be preloaded on a computing device prior to the first sale of the device, or they may be uploaded to the device via an information interface and/or a removable media after the first sale. As such, the game instructions may be stored at a memory location external to the device, such as at a game distribution server and/or on removable media that a user can purchase or otherwise acquire, before being loaded onto the device.

FIG. 2 shows a nonlimiting example of a computing device 10 in the form of a mobile phone 50. Mobile phone 50 can be used to send and receive mobile telephone calls, such as via cellular or satellite networks. Mobile phone 50 includes a display 52 and a user input 54. User input 54 includes a numeric keypad 56 including a plurality of number keys (e.g., 1, 2, 3, 4, 5, 6, 7, 8, 9, *, 0, and #). User input 54 also includes a directional keypad 58 in the form of a joystick, softkeys 60a, 60b, and 60c, a “back” key 62, and a cancel key 64. The illustrated embodiment shows a nonlimiting example of a user input, and user inputs having additional and/or alternative input mechanisms are within the scope of this disclosure. Furthermore, user inputs that have a different arrangement of input mechanisms are within the scope of this disclosure.

User input 54 can be arranged for one-handed operation. For example, the various keys and other input mechanisms of the user input can be positioned so that they can be activated by a user's thumb while the device is cradled in the user's palm or held by the user's fingers.

FIG. 2 shows mobile phone 50 while executing a game program. The game program includes a virtual three-dimensional environment that is presented on display 52 from the first-person perspective of a virtual game character. As shown, the view includes a street, buildings, a helicopter, a wall, and enemies. Other portions of the three-dimensional environment can be presented as the game perspective is changed. For example, the game program can be configured so that directional keypad 58 causes the game character to move forward or backward and turn left or right within the virtual three-dimensional environment. In some embodiments, various input mechanisms can be used to cause the game character to look up or down, sidestep left or right, and/or move in other patterns. Alternatively, a game character's movement throughout a virtual environment can automatically be controlled by the game controller. As the character moves or otherwise looks in different directions, the content presented on display 52 changes to reflect the perspective of the game character.

FIG. 2 also shows a grid 70 that functionally divides the display into a 3×3 matrix of display segments. As the game perspective changes, the content presented in each display segment can change. Display segments can be visually framed by lines and/or other indicators that can be perceived by a viewer. Display segments can alternatively be displayed without any visible lines or other indicators that graphically separate the segments.

A subset of user input 54 can be mapped to the display so that each display segment corresponds to a particular input mechanism. As used herein, a “subset” can include all elements of the base set (i.e., B⊂A). In the illustrated example, each display segment corresponds to one of the number keys of keypad 56. In particular, number keys 1-9 are arranged in a 3×3 matrix, and each of number keys 1-9 is mapped to the display segment that has the same relative position in the 3×3 matrix of display segments as that number key has in the 3×3 matrix of number keys. For example, the 1 key is mapped to the upper left display segment, the 5 key is mapped to the center display segment, and the 9 key is mapped to the lower right display segment. As used herein, the “1 segment” can be used to refer to the display segment to which the 1 key is mapped, the “2 segment” can be used to refer to the display segment to which the 2 key is mapped, and so on.

A display can be divided into virtually any number of segments, and the segments can be sized, shaped, and positioned accordingly. As a practical matter, a display need not be divided into more segments than the user input has input mechanisms which can be mapped to the display segments. However, a game program can be configured so that a key combination (i.e., simultaneously activating two or more keys) can allow for increased display segmentation. As a nonlimiting example, FIG. 3 shows a 3×3 matrix of keys mapped to a 5×5 matrix of display segments, where some display segments correspond to a 2 or 4 key combination. Increased segmentation can allow for increased resolution and/or accuracy, thus facilitating advanced gameplay.

The display may be divided into fewer segments than there are available input mechanisms. For example, FIG. 2 shows a 3×3 matrix of display segments to which keys 1-9 are mapped. Although keypad 56 includes a 3×4 matrix of number keys, the display does not include a 3×4 matrix of display segments. The * key, 0 key, and 3 key are not mapped to display segments. Furthermore, the softkeys, back key, cancel key, and directional keypad are not mapped to display segments. Such keys are left available for other game functions, thus providing control diversity.

One object of the game illustrated in FIG. 2 is to shoot enemies without shooting allies. This is a common theme in what has become to be known as first-person-shooter games, which are so named because of the first-person perspective of the game character. A variety of different game elements can be incorporated with the basic theme of shooting enemies in order to add depth to gameplay (e.g., finding weapons, treasures, or prizes; solving riddles; freeing hostages, etc.). Furthermore, the types of three-dimensional environments, weapons, enemies, vehicles, and other aspects of the game can be customized in order to differentiate one first-person-shooter game from another.

In first-person-shooter games, the weapons that the virtual game character “fires” must be aimed. The sophistication of aiming systems can vary from one game to another. Some games can be configured so that a game character automatically fires directly at an enemy that is presented on the display, no matter where the enemy is located on the display. In other words, aiming is not necessary. Such an aiming system can limit complicated and challenging gameplay due to its simplistic nature. Some games may be configured so that a game character always fires straight ahead (i.e., at the center of the three-dimensional environment that is presented on the display). This type of aiming system, though providing more of a challenge than the previously described aiming system, also can be considered to be limiting by some game players. In some games, one input mechanism can be used to control game perspective, while another input mechanism is used to move a virtual bull's-eye within the perspective so that virtual objects occupying portions other than the center of the display can be shot. Such an aiming system can require relatively complex user inputs and/or relatively powerful game processors, which are not available on all types of devices (e.g., some mobile phones). Such an aiming system also may be more complicated than some game players prefer.

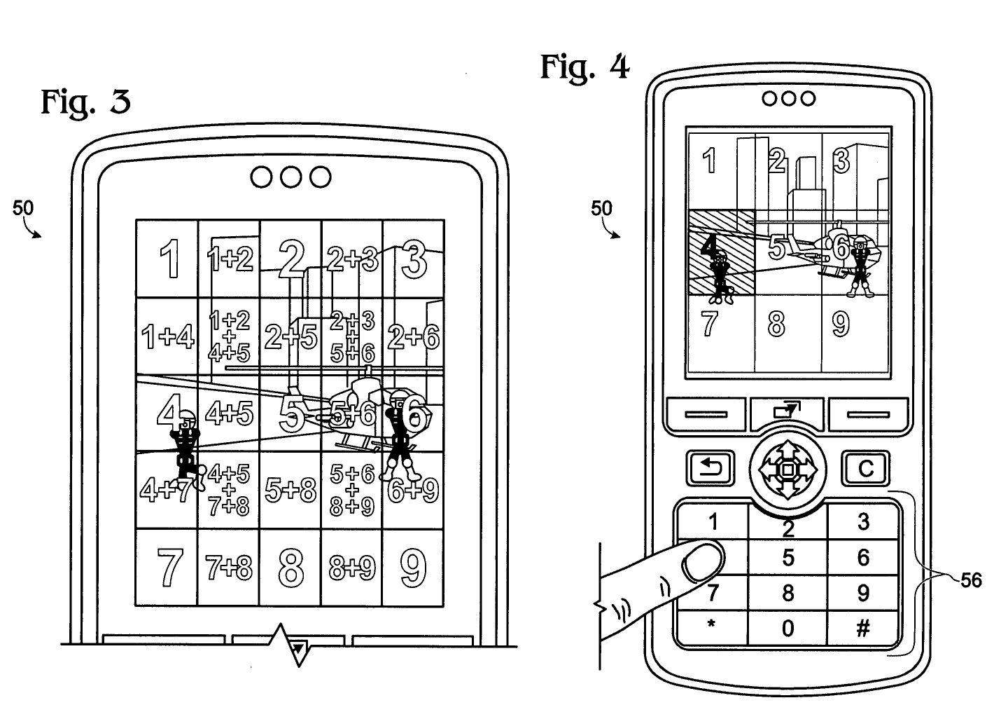

Games according to the present disclosure can be configured so that a game character can fire at a particular display segment by activating the input mechanism that is mapped to that display segment. As an example, FIG. 2 shows an enemy in the display segment to which the 4 key is mapped (i.e., the 4 segment). As shown in FIG. 4, the 4 key can be activated to fire at the enemy in the 4 segment. In this manner, the enemy in the 4 segment can be fired at without changing the game perspective to move that enemy into the center of the display. Furthermore, the enemy in the 4 segment can be fired at without carefully positioning a bull's-eye (or equivalent) over that enemy. Such an aiming system can be easily implemented with a numeric keypad, or other relatively simplistic user input, as is commonly found on a mobile phone or other portable computing device.

Such an aiming system allows for fast-paced gameplay in which a virtual game character is able to quickly fire at targets positioned far apart from one another. For example, the game character can fire at an enemy positioned in the 1 segment (top, left corner), and without changing game perspective or moving a virtual bull's-eye, fire at an enemy positioned at the 9 segment (bottom, left corner). Enemies can be introduced at a fast pace at different display segments, thus challenging a user to quickly activate the input mechanism corresponding to the display segment where the targeted enemy is located. The rate at which enemies located apart from one another can be targeted is increased because changing game perspective and/or bull's-eyeing is not required.

While the above described aiming system allows a game character to fire without changing game perspective, this is not required. An input mechanism can be used to change game perspective. Mapped input mechanisms can be activated to fire at corresponding display segments before, during, or after game perspective changes. As a nonlimiting example, directional keypad 58 can be used to move the game character, thus changing game perspective and number keys 1-9 can be used to fire at corresponding display segments.

While the present disclosure uses a first-person-shooter game as an example, user input mechanisms can be mapped to corresponding regions of a display in completely different game genres, or even applications other than games. The virtual game environment illustrated and described herein is a nonlimiting example of one suitable environment for mapping input mechanisms to display segments. A variety of completely different environments can be used in a variety of different game genres or different application genres.

While the example of firing a weapon is provided as an exemplary action that can be targeted by mapped keys to different display segments, it should be understood that virtually any other targetable action can be performed in this way. As nonlimiting examples, such an aiming system can be used to select which display segment a virtual game character photographs, from which display segment a virtual game character grabs an object, or to which display segment the game character deposits an object.

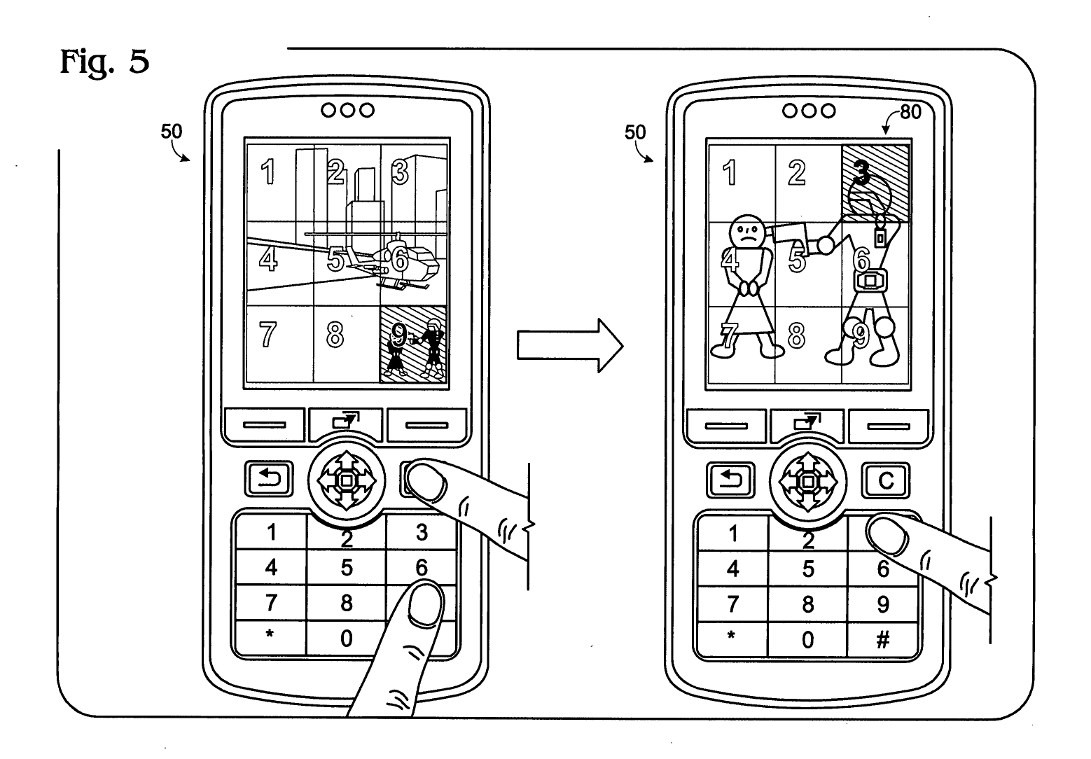

A targeting system that maps input mechanisms to display segments can be used with a key combination so that a secondary targeting finction can be performed. For example, as a primary function, the above display-mapping targeting system fires a weapon at a display segment to which an activated input mechanism is mapped. As a secondary finction that can be triggered by simultaneously activating the cancel key (C), for example, with a display-segment selection key (1-9), a game can be configured so that a telescope zooms onto a targeted display segment. For example, in FIG. 5 an enemy is holding an ally hostage in the 9 segment. The 9 number key and the cancel key can be simultaneously selected (9+C) so that instead of shooting at the enemy and the ally, the virtual game character uses a telescope to zoom onto the 9 segment. As shown generally at 80, by zooming onto the 9 segment, a game character can fire at the 3 segment without risking injury to the ally. Such zooming can be incorporated into a game in various ways, including creating more challenging shots and/or providing an opportunity to earn increased points/experience for performing more accurate and/or difficult shots.

Key combinations can additionally or alternatively be used to activate a number of different game actions. For example, each of soft keys 60a, 60b, and 60c can be combined with numeric keys 1-9 to fire a different weapon at display segments 1-9. As a different example, back key 62 can be combined with numeric keys 1-9 to enter a building or vehicle door located at the corresponding display segment.

The present disclosure has been provided with reference to a nonlimiting subset of the various embodiments and operational principles defined by the appended claims. It will be apparent to those skilled in the art that various changes in form and detail may be made without departing from the spirit and scope of the claims. Accordingly, the claims should not be interpreted as being limited to the particular embodiments disclosed herein, but rather, should be afforded the full breadth that they define. The present disclosure is intended to embrace all such alternatives, modifications and variations. Where the disclosure or claims recite “a,” “a first,” or “another” element, or the equivalent thereof, they should be interpreted to include one or more such elements, neither requiring nor excluding two or more such elements.

1. A mobile phone, comprising:
a display;
a numeric keypad including a plurality of number keys;
a controller configured to receive input commands from the numeric keypad and to deliver video information to the display; and
a memory holding game instructions that, when executed by the controller, map a subset of the numeric keypad to the display such that the display is functionally divided into a plurality of segments, one for each mapped number key, and where each mapped number key controls game action at the display segment to which that key is mapped.

2. The mobile phone of claim 1, where the subset of the numeric keypad includes a 3×3 matrix of number keys, and where the display is functionally divided into a corresponding 3×3 matrix of display segments.

3. The mobile phone of claim 1, further comprising a directional keypad, where the memory holds game instructions that, when executed by the controller, enables the directional keypad to change game perspective, thus changing content displayed in each of the plurality of display segments.

4. The mobile phone of claim 1, where the game instructions are a constituent portion of a three-dimensional, first-person-shooter, game program.

5. The mobile phone of claim 1, where relative position of the plurality of display segments is substantially the same as relative position of the plurality of mapped number keys.

6. The mobile phone of claim 1, where the memory holds instructions allowing a different game action to be performed at the display segment to which a number key is mapped when that mapped number key is used in a key combination.

7. The mobile phone of claim 1, where the mobile phone is configured for one-handed holding and operation, where the mapped number keys are arranged for activation by a thumb of a hand holding the mobile phone.

8. A computing device, comprising:
a display;
a user input including a plurality of different input mechanisms;
a controller configured to receive input commands from the user input and to deliver video information to the display; and
a memory holding game instructions that, when executed by the controller, map a subset of the user input to the display such that the display is functionally divided into a plurality of segments, one for each mapped input mechanism, and where each mapped input mechanism controls game action at the display segment to which that input mechanism is mapped.

9. The computing device of claim 8, where the subset of the user input includes a 3×3 matrix of keys, and where the display is functionally divided into a corresponding 3×3 matrix of display segments.

10. The computing device of claim 8, where relative position of the plurality of display segments is substantially the same as relative position of the plurality of mapped input mechanisms.

11. The computing device of claim 8, where the user input includes a directional input, and where the memory holds game instructions that, when executed by the controller, enables the directional input to change game perspective, thus changing content displayed in each of the plurality of display segments.

12. The computing device of claim 8, further comprising a cellular radio.

13. The computing device of claim 8, further comprising a satellite transceiver.

14. The computing device of claim 8, where the computing device is configured for one-handed holding and operation.

15. The computing device of claim 14, where the mapped input mechanisms are arranged for activation by a thumb of a hand holding the computing device.

16. The computing device of claim 8, where the memory holds instructions allowing a different game action to be performed at the display segment to which a user input is mapped when that mapped user input is used in combination with another user input.

17. A memory holding game instructions configured for execution on a mobile computing device, where the game instructions, when executed by the mobile computing device, render a portion of a three-dimensional virtual environment on a display of the mobile computing device and map a plurality of input keys to the displayed portion of the three-dimensional virtual environment such that the displayed portion of the three-dimensional virtual environment is functionally divided into a plurality of segments, one for each mapped input key, and where each mapped input key controls game action at the segment of the three-dimensional virtual environment to which that input key is mapped.

18. The memory of claim 17, where the game instructions, when executed by the mobile computing device, enable a directional input of the mobile computing device to change game perspective within the three-dimensional virtual environment, thus changing which portion of the three-dimensional virtual environment is displayed in each of the plurality of display segments.

19. The memory of claim 17, where the memory holds instructions allowing a different game action to be performed at the display segment to which a user input is mapped when that mapped user input is used in combination with another user input.

20. A method of targeting in a game, comprising:
presenting a virtual game environment on a display;
functionally dividing the virtual game environment into a plurality of segments;
mapping a key to each segment; and
upon activation of a mapped key, initiating a game action at the display segment to which the key is mapped.

21. The method of claim 20, where functionally dividing the virtual game environment into a plurality of segments includes functionally dividing the virtual game environment into a 3×3 matrix of segments.

22. The method of claim 21, where the mapped keys are arranged in a 3×3 matrix, and where mapping a key to each segment includes mapping a key having a relative position in the 3×3 matrix of keys to the segment having the same relative position in the 3×3 matrix of segments.
